(19) United States
(12) Patent Application Publication
(10) Pub. No.: US 2010/0142541 A1
(43) Pub. Date: Jun. 10, 2010

(54) COMMUNICATION SYSTEM

(76) Inventors: Yusuke MURASE, Fujisawa (JP); Mitsuhiro Yamaguchi, Yokohama (JP); Takeshi Kawamoto, Yokohama (JP); Toshiyuki Matsuda, Yokohama (JP); Yusuke Honda, Kawasaki (JP); Masahiro Kosaka, Fujisawa (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/626,773

(22) Filed: Nov. 27, 2009

(30) Foreign Application Priority Data
Nov. 28, 2008 (JP) 2008-303417

(51) Int. Cl. H04L 12/56; H04J 3/22

(52) U.S. Cl. 370/400; 370/466

(57) ABSTRACT

A media gateway is configured to include a subscriber loop interface circuit, and TDM data-IP packet convert modules #0 and #1 having a redundant configuration and connected to an Internet protocol network via routers. The TDM data-IP packet convert modules #0 and #1 have a function of conducting communication of communication information, a synchronize signal, and IP packet data received from the Internet protocol network, between their active system and standby system. In system changeover, the TDM data-IP packet convert module #0 functioning as the active system transmits the IP packet data received from the Internet protocol network, to the block #1 functioning as the standby system, and both systems execute IP packet data communication synchronously. When IP packet data communication of the standby system is ensured, the standby system and the active system are changed over to vice versa.

### INCORPORATION BY REFERENCE

The present application claims priority from Japanese application JP 2008-303417 filed on Nov. 28, 2008, the content of which is hereby incorporated by reference into this application.

### BACKGROUND OF THE INVENTION

The present invention relates to a system changeover scheme in a TDM data-IP packet convert module and a media gateway apparatus having the TDM data-IP packet convert module. In particular, the present invention relates to a system changeover method in a TDM data-IP packet convert module included in a media gateway apparatus, which conducts conversion between existing telephone communication and VOICE Over IP, i.e., a communication media change between time division multiplex communication and packet communication, and the media gateway apparatus.

As a conventional art concerning the active/standby changeover method of a TDM data-IP packet convert module included in a media gateway apparatus, a technique described in, for example, JP-A-2005-57461 is known.

According to the conventional art, communication information on the packet network side in the media gateway apparatus is transferred between the active system and the standby system, and consequently it is made possible to continue the communication executed by the active system until then even after the standby system has become an active system as a result of system changeover. When the active system becomes an standby system in the conventional art, the standby system is disconnected from an Internet protocol network so as to prevent two devices having the same address from existing in the network simultaneously and communication is continued using the communication information taken over.

### SUMMARY OF THE INVENTION

In the conventional art, system changeover is conducted in the state in which an IP packet network interface in the standby system is disconnected from the network, and changeover to a system that cannot conduct communication is conducted. Ascertainment of a communication situation between the standby system and various devices in the IP packet network or the packet network is conducted at the time when the standby system has taken over the active system. Therefore, the conventional art has a problem that it is not ensured to be immediately capable of conducting communication at the time when the standby system has started working and a time period during which the communication becomes impossible occurs when the standby system takes over the active system. If the taking over is caused by apparatus maintenance, such a problem impairs the continuation of service and it is not undesirable. Especially in data communication other than voices, for example, in information in a financial system or a security system using a telephone line, a hindrance is caused in service by data missing and consequently communication impossible time cannot be allowed.

An object of the present invention is to solve the above-described problem of the conventional art and provide a TDM data-IP packet convert module changeover method capable of conducting system changeover without causing a communication impossible state in a media gateway apparatus, in which the TDM data-IP packet convert modules have a redundant configuration and system changeover is conducted due to fault occurrence, regular changeover executed by a telephone exchange, or a maintenance procedure, and provide such a media gateway apparatus.

As an example, a communication system according to the present invention is a communication system including a first terminal, a second terminal, a first manage module connected to the first terminal, a second manage module connected to the second terminal and connected to the first manage module via an Internet protocol (IP) network, and a clock supply module connected to the first manage module and the second manage module, wherein the clock supply module transmits a synchronize signal to the first manage module and the second manage module, the first manage module includes a first circuit for converting a signal to be transmitted to the first terminal and a signal received from the first terminal, a first convert module for receiving a signal transmitted from the first circuit and converting time division multiplexed (TDM) data to IP packets and vice versa, and a second convert module for receiving a signal transmitted from the first circuit, and converting TDM data to IP packets and vice versa, and the first convert module and the second convert module synchronize IP packet processing by using the synchronize signal supplied from the clock supply module.

As an example, a system changeover method according to the present invention is a system changeover method for time division multiplexed (TDM) data-IP packet convert modules in a media gateway apparatus which includes a subscriber loop interface circuit, and a TDM data-IP packet convert module and which converts TDM data to IP packet data and vice versa. Between the TDM data-IP packet convert modules which assume the redundant configuration, communication of communication information for causing a standby system to have the same communication setting as an active system does, a synchronize signal for synchronizing the standby system with the active system, and IP packet data received from an Internet protocol network is conducted. The TDM data-IP packet convert module functioning as the active system and the TDM data-IP packet convert module functioning as the standby system are caused to always operate in synchronism with each other by the synchronize signal. While system changeover processing is being executed, the TDM data-IP packet convert module functioning as the active system conducts mirroring on IP packet data received from the Internet protocol network and transmits the IP packet data to the TDM data-IP packet convert module functioning as the standby system, and the same IP address is set for the TDM data-IP packet convert module functioning as the active system and the TDM data-IP packet convert module functioning as the standby system. The active system and the standby system are caused to execute packet data communication with the Internet protocol network. After IP packet data communication is ensured for the standby system, the TDM data-IP packet convert module functioning as the standby system is changed over to the active system and the TOM data-IP packet convert module functioning as the active system is changed over to the standby system. As a result, suitable system changeover is accomplished.

In a media gateway apparatus which includes a subscriber loop interface circuit and a time division multiplexed (TDM) data-IP packet convert modules having a redundant configuration and connected to an Internet protocol network and which conducts mutual conversion between TDM data and IP packet data, it is possible to improve the continuation of the communication quality during system changeover and eliminate the communication impossible time during system changeover.

Other objects, features and advantages of the invention will become apparent from the following description of the embodiments of the invention taken in conjunction with the accompanying drawings.

### BRIEF DESCRIPTION OF THE DRAWINGS

FIG. 1 is a connection diagram of gateways according to an embodiment of the present invention;

FIG. 2 is an internal configuration diagram of a gateway;

FIG. 3 is a diagram for explaining, as to a flow in the forward direction, an operation sequence in the case where a state in which a TDM data-IP packet convert module #0 (TDM data-IP packet convert module #1) functions as the active system and a TDM data-IP packet convert module #1 (TDM data-IP packet convert module #0) functions as the standby system is changed over to a state in which the TDM data-IP packet convert module #1 (TDM data-IP packet convert module #0) functions as the active system and the TDM data-IP packet convert module #0 (TDM data-IP packet convert module #1);

FIG. 4 is a diagram for explaining, as to a flow in the backward direction, an operation sequence in the case where a state in which the TDM data-IP packet convert module #0 (TDM data-IP packet convert module #1) functions as the active system and the TDM data-IP packet convert module #1 (TDM data-IP packet convert module #0) functions as the standby system is changed over to a state in which the TDM data-IP packet convert module #1 (TDM data-IP packet convert module #0) functions as the active system and the TDM data-IP packet convert module #0 (TDM data-IP packet convert module #1) functions as the standby system; and

FIG. 5 is a diagram showing a method by which the TDM data-IP packet convert module #1 (the TDM data-IP packet convert module #0) generates the same TDM data and the same IP packets as those in the TDM data-IP packet convert module #0 (the TDM data-IP packet convert module #1).

### DESCRIPTION OF THE EMBODIMENTS

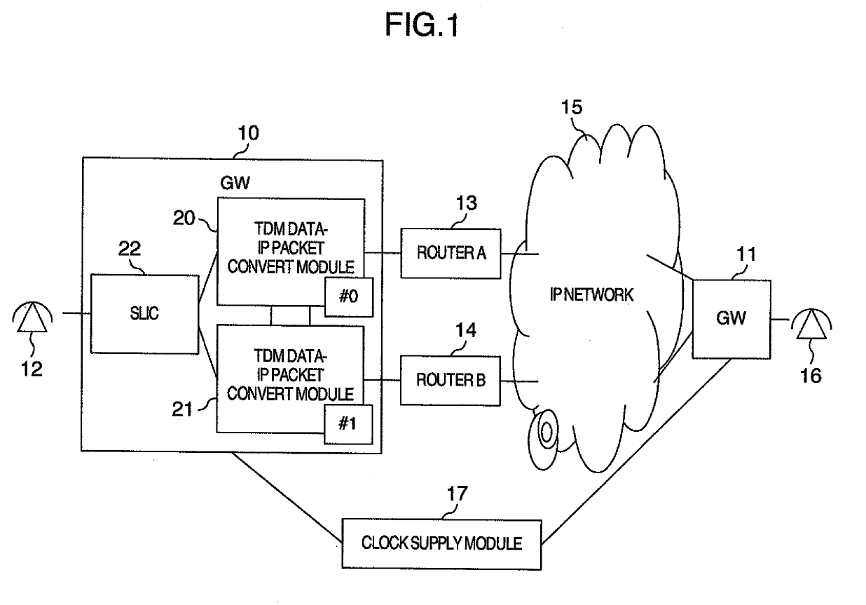

FIG. 1 is a connection diagram of gateways (manage modules) according to an embodiment of the present invention. Reference numerals 10 and 11 denote gateways (manage modules), 12 and 16 subscriber terminals, 13 a router A, 14 a router B, 15 an Internet protocol network, 17 a clock supply module, 20 a first

TDM data-IP packet convert module #0, 21 a second TDM data-IP packet convert module #1, and 22 a subscriber loop interface circuit (SLIC). Here, the TDM data-IP packet convert module is a module for converting a time division multiplexed (TDM) data signal to IP packets and converting IP packetized data signal to a time division multiplexed (TDM) data signal. Although not illustrated, a configuration having a router between the gateway 11 and the Internet protocol network 15 as well is used for the backward information communication sequence. Although not illustrated, the gateway 11 includes a TDM data-IP packet convert module, and the gateway 11 may have the same internal configuration as the gateway 10.

The direction facing from the subscriber terminal 12 to the subscriber terminal 16 is referred to as forward direction, and the direction facing from the subscriber terminal 16 to the subscriber terminal 12 is referred to as backward direction.

The subscriber terminal 12 is a telephone terminal, a modem or the like. In the forward direction, the subscriber terminal 12 transmits an analog signal or a digital signal (hereafter referred to as data signal) to the subscriber loop interface (IF) circuit 22 in the gateway 10. In the backward direction, the subscriber terminal 12 receives a data signal from the subscriber loop interface circuit 22 in the gateway 10.

The gateway 10 includes the subscriber loop interface circuit 22, the TDM data-IP packet convert module #0 20, and the TDM data-IP packet convert module #1 21. The gateway 10 has multiplexed (here, duplicated) TDM data-IP packet convert modules so as to prevent service in active from being stopped. Changeover between the active system and the standby system is conducted regularly in order to conduct maintenance work such as data backup. The gateway 10 receives clock signals of 0.4 kHz, 8 kHz, 64 kHz and so on (hereafter referred to as clock signals) from the clock supply module 17.

In the forward direction, the subscriber loop interface circuit 22 receives a data signal from the subscriber terminal 12, converts the data signal to TDM data, and transmits the TDM data to both the TDM data-IP packet convert module #0 20, and the TDM data-IP packet convert module #1 21. In the backward direction, the subscriber loop interface circuit 22 converts either TDM data received from the TDM data-IP packet convert module #0 20 or TDM data received from the TDM data-IP packet convert module #1 21 to a data signal, and transmits the data signal to the subscriber loop interface circuit 12.

In the forward direction, the TDM data-IP packet convert module #0 20 (TDM data received from the TOM data-IP packet convert module #1 21) (hereafter, as for descriptions related to 20 and 21, basically descriptions without parentheses correspond to each other, and descriptions in parentheses correspond to each other) converts TDM data received from the subscriber loop interface circuit 22 to IP packets directed to the opposite gateway 11, and transmits the IP packets to the router A 13 (the router B 14). In 5. the backward direction when operating in the active system, the TDM data-IP packet convert module #0 20 (TDM data received from the TDM data-IP packet convert module #1 21) in the active system converts IP packets received from the router A 13 (the router B 14) to TDM data, and transmits the TDM data to the subscriber loop interface circuit 22. The TDM data-IP packet convert module #0 20 (TDM data received from the TDM data-IP packet convert module #1 21) in the standby system does not conduct transmission of IP packets in the forward direction and transmission of TDM data.

At the time of system changeover, the TDM data-IP packet convert module #0 20 (the TDM data-IP packet convert module #1 21) transmits IP packets to the TDM data-IP packet convert module #1 21 (the TDM data-IP packet convert module #0 20) or receives IP packets from the TDM data-IP packet convert module #1 21 (the TDM data-IP packet convert module #0 20). At the time of system changeover, the TDM data-IP packet convert module #0 20 (the TDM data-IP packet convert module #1 21) transmits a system changeover order to or receives a system changeover order from the TDM data-IP packet convert module #1 21 (the TDM data-IP packet convert module #0 20).

The TDM data-IP packet convert module #0 20 (the TDM data-IP packet convert module #1 21) transmits communication information such as opposite gateway information and subscriber information to or receives communication information from the TDM data-IP packet convert module #1 21 (the TDM data-IP packet convert module #0 20) to match communicating settings to each other and continue the service even when system changeover is executed. Furthermore, the TOM data-IP packet convert module #0 20 (the TDM data-IP packet convert module #1 21) transmits a synchronize signal for IP packet processing to or receives a synchronize signal for IP packet processing from the TDM data-IP packet convert module #1 21 (the TOM data-IP packet convert module #0 20) to make timing of IP packet processing coincide with each other.

The TDM data-IP packet convert module #0 20 (the TDM data-IP packet convert module #1 21) uses an active system IP address when it functions as the active system and uses a standby system IP address when it functions as the standby system. The active system IP address and the standby system IP address are values common to the TOM data-IP packet convert module #0 20 and the TDM data-IP packet convert module #1 21. At the time of system changeover, the TDM data-IP packet convert module #0 20 (the TDM data-IP packet convert module #1 21) changes the IP address to be used. At the time of system changeover, the TDM data-IP packet convert module #0 20 (the TDM data-IP packet convert module #1 21) notifies the router A 13, the router B 14, the Internet protocol network 15 and the gateway 11 that the IP address have been changed by using routing change information (hereafter referred to as GARP (Generic Attribute Registration Protocol)).

In the forward direction, the router A 13 (the router B 14) transmits IP packets directed to the gateway 11 received from the TDM data-IP packet convert module #0 20 (the TDM data-IP packet convert module #1 21), to the Internet protocol network 15. In the backward direction, the router A 13 (the router B 14) receives IP packets directed to an active system IP address in the gateway 10, from the Internet protocol network 15. If the router A 13 (the router B 14) recognizes that the active system IP address in the gateway 10 corresponds to the TDM data-IP packet convert module #0 20 (the TDM data-IP packet convert module #1 21) by referring to a routing table included in itself, then the router A 13 (the router B 14) transmits IP packets directed to the active system IP address in the gateway 10, to the TDM data-IP packet convert module #0 20 (the TDM data-IP packet convert module #1 21). The router A 13 (the router B 14) updates the routing table by receiving the GARP transmitted by the TDM data-IP packet convert module #0 20 (the TOM data-IP packet convert module #1 21).

The Internet protocol network 15 includes routers. In the forward direction, the Internet protocol network 15 transmits IP packets directed to the gateway 11 received from the router A 13 (the router B 14), to the gateway 11. In the backward direction, the Internet protocol network 15 receives IP packets directed to an active system IP address in the gateway 10, from the gateway 11. The Internet protocol network 15 transmits the IP packets directed to an active system IP address in the gateway 10 to either the router A13 or the router B14 by using its internal routing. The Internet protocol network 15 changes its internal routing by receiving the GARP transmitted by the TDM data-IP packet convert module #0 20 (the TDM data-IP packet convert module #1 21).

In the forward direction, the gateway 11 converts IP packets received from the Internet protocol network 15 to a data signal, and transmits the data signal to the subscriber terminal 16. In the backward direction, the gateway 11 converts a data signal received from the subscriber terminal 16 to IP packets directed to an active system IP address in the gateway 10, and transmits the IP packets to the Internet protocol network 15. Upon receiving the GARP, the gateway 11 updates the routing information. The gateway 11 receives the clock signals from the clock supply module 17 in the same way as the gateway 10.

The subscriber terminal 16 is a telephone terminal, a modem or the like. In the forward direction, the subscriber terminal 16 receives a data signal from the gateway 11. In the backward direction, the subscriber terminal 16 transmits a data signal to the gateway 11. The clock supply module 17 transmits the clock signals to the gateway 10 and the gateway 11.

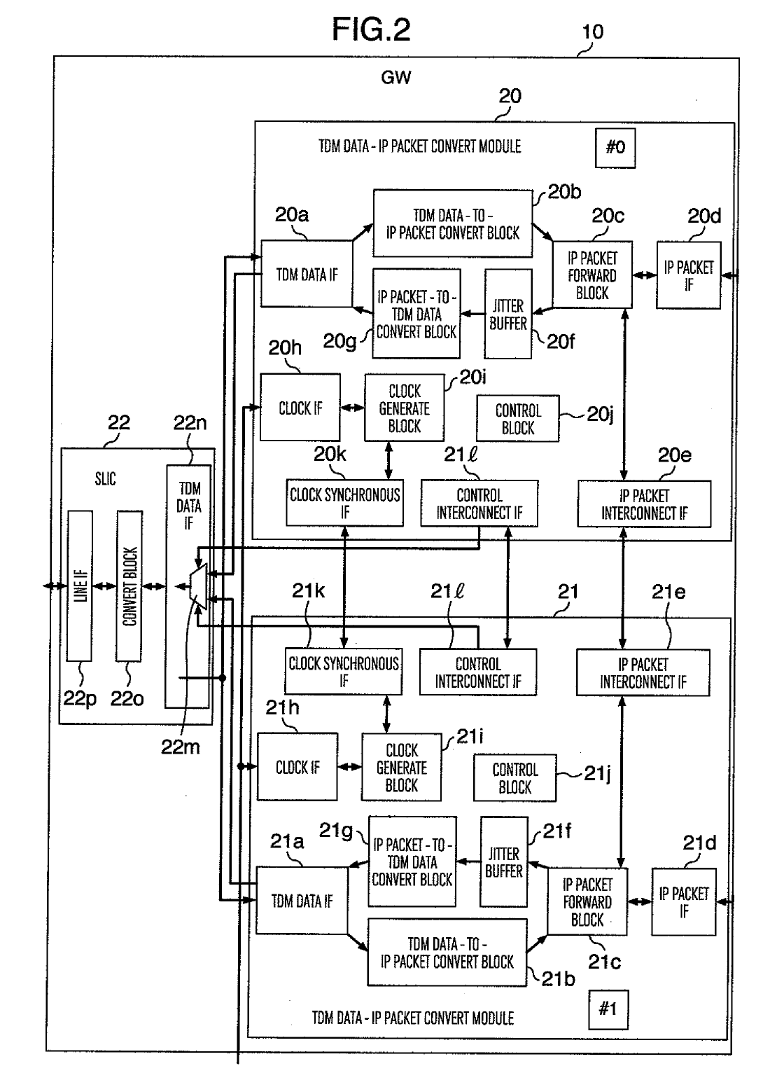

FIG. 2 is an internal configuration diagram of a gateway. Reference characters 20a and 21a denote TDM data interfaces, 20b and 21b TDM data-to-IP packet convert blocks, 20c and 21c IP packet forward blocks, 20d and 21d IP packet interfaces, 20e and 21e IP packet interconnect interfaces, 20f and 21f jitter buffers, 20g and 21g IP packet-to-TDM data convert blocks, 20h and 21h clock interfaces, 20i and 21i clock generate blocks, 20j and 21j control blocks, 20k and 21k clock synchronous interfaces, 201 and 211 control interconnect interfaces, 22m a selector, 22n a TDM data interface, 22o a convert block, and 22p a line interface.

The TDM data-IP packet convert module #0 20 (the TDM data-IP packet convert module #1 21) includes the TDM data interface 20a (21a), the TOM data-to-IP packet convert block 20b (21b), the IP packet forward block 20c (21c), the IP packet interface 20d (21d), the IP packet interconnect interface 20e (21e), the jitter buffer 20f (21f), the IP packet-to-TDM data convert block 20g (21g), the clock interface 20h (21h), the clock generate block 20i (21i), the control block 20j (21j), the clock synchronous interface 20k (21k), and the control interconnect interface 201 (211). The subscriber loop interface circuit 22 includes the selector 22m, the TDM data interface 22n, the convert block 22o and the line interface 22p.

The control block 20j (21j) issues an order to each of the TDM data-to-IP packet convert block 20b (21b), the IP packet-to-TDM data convert block 20g (21g), the jitter buffer 20f (21f), the IP packet forward block 20c (21c), and the clock generate block 201 (21i) to operate it. The control block 20j (21j) generates a system changeover order on the basis of a maintenance command or a predetermined schedule, and transmits the system changeover order to the control interconnect interface 201 (211). The control block 20j (21j) conducts system changeover on the basis of a system changeover order received from the control interconnect interface 201 (211). At the time of system changeover, the control block 20j (21j) generates the GARP, and transmits the GARP to the control interconnect interface 201 (211). The control block 20j (21j) generates communication information on the basis of current communication setting, and transmits the communication information to the IP packet interconnect interface 20e (21e). The control block 20j (21j) receives communication information from the IP packet interconnect interface 20e (21e), and updates the communication setting.

In the forward direction, the TDM data interface 20a (21a) transmits TDM data received from the TDM data interface 22n, to the TDM data-to-IP packet convert block 20b (21b). In the backward direction, the TDM data interface 20a (21a) transmits TDM data received from the IP packet-to--TDM data convert block 20g (21g), to the selector 22m in the TDM data interface 22n.

In the forward direction, the TDM data-to-IP packet convert block 20b (21b) receives TDM data from the TDM data interface 20a (21a), and converts the received TDM data to IP packets in accordance with a synchronize signal having a repetition period of, for example, 20 ms (hereafter referred to as synchronize signal) supplied from the clock generate block 20i (21i). And the TDM data-to-IP packet convert block 20b (21b) transmits the generated IP packets to the IP packet forward block 20c (21c).

In the forward direction when operating in the active system, the IP packet forward block 20c (21c) transmits the IP packets received from the TDM data-to-IP packet convert block 20b (21b), to the IP packet interface 20d (21d). In the forward direction when operating in the standby system, however, the IP packet forward block 20c (21c) does not transmit the IP packets received from the TDM data-to-IP packet convert block 20b (21b), to the IP packet interface 20d (21d). In the forward direction when changeover from the active system to the standby system is conducted, the IP packet forward block 20c (21c) stops transmission of the IP packets received from the TDM data-to-IP packet convert block 20b (21b), to the IP packet interface 20d (21d). In the forward direction when changeover from the standby system to the active system is conducted, the IP packet forward block 20c (21c) starts transmission of the IP packets received from the TDM data-to-IP packet convert block 20b (21b), to the IP packet interface 20d (21d).

In the backward direction when operating in the active system and when operating in the standby system, the IP packet forward block 20c (21c) transmits IP packets received from the IP packet interface 20d (21d), to the jitter buffer 20f (21f). In the backward direction when changeover from the active system to the standby system is conducted, the IP packet forward block 20c (21c) conducts mirroring on each of IP packets received from the IP packet interface 20d (21d), and transmits one IP packet to the jitter buffer 20f (21f) and transmits the other IP packet to the IP packet interconnect interface 20e (21e). In the backward direction when changeover from the standby system to the active system is conducted, the IP packet forward block 20c (21c) receives IP packets from two directions, i.e., from the IP packet interface 20d (21d) and the IP packet interconnect interface 20e (21e), and transmits the IP packets to the jitter buffer 20f (21f).

The IP packet interface 20d (21d) transmits IP packets received from the IP packet forward block 20c (21c), to the router A 13 (the router B 14). The IP packet interface 20d (21d) transmits IP packets received from the router A 13 (the router B 14), to the

IP packet forward block 20c (21c). The IP packet interface 20d (21d) transmits the GARP received from the control block 20j (21j), to the router A 13 (the router B 14).

The IP packet interconnect interface 20e (21e) transmits IP packets and communication information received from the IP packet forward block 20c (21c), to the IP packet interconnect interface 21e (20e). The IP packet interconnect interface 20e (21e) transmits IP packets and communication information received from the IP packet interconnect interface 21e (20e), to the IP packet forward block 20c (21c).

In the backward direction, the jitter buffer 20f (21f) ascertains that IP packets received from the IP packet forward block 20c (21c) includes an IP packet having a destination which coincides with an IP address of the own system. If IP packets having the same sequence number are received doubly, a packet received later is discarded. Upon storing a determinate number of IP packets in a buffer, the jitter buffer 20f (21f) transmits IP packets to the IP packet-to-TDM data convert block 20g (21g) in the order of a sequence number in accordance with the synchronize signal supplied from the clock generate block 20i (21i). Even if the dispersion in delay of IP packets is large, the jitter buffer 20f (21f) avoids missing of TDM data by transmitting packets stored until then.

In the backward direction, the IP packet-to-TDM data convert block 20g (21g) receives IP packets from the jitter buffer 20f (21f), and converts the received IP packets to TOM data in accordance with a synchronize signal (for example, a signal having a repetition period of 20 ms) received from the clock generate block 20i (21i). And the IP packet-to-TDM data convert block 20g (21g) transmits the generated TDM data to the TOM data interface 20a (21a).

The clock interface 20h (21h) transmits clock signals received from the clock supply module 17 to the clock generate block 20i (21i).

The clock generate block 20i (21i) generates clocks required for operations of respective blocks on the basis of the clock signals received from the clock interface 20h (21h), and transmits the clocks to the

TDM data interface 20a (21a), the TDM data-to-IP packet convert block 20b (21b), the IP packet forward block 20c (21c), the IP packet interface 20d (21d), the IP packet interconnect interface 20e (21e), the jitter buffer 20f (21f), the IP packet-to-TDM data convert block 20g (21g), the clock interface 20h (21h), the control block 20j (21j), the clock synchronous interface 20k (21k), and the control interconnect interface 201 (211). The clock generate block 20i (21i) generates a synchronize signal for IP packet processing on the basis of clock signals received from the clock interface 20h (21h). The clock generate block 20i (21i) receives a synchronize signal from the clock synchronous interface 20k (21k) as well. The clock generate block 20i (21i) transmits either a synchronize signal generated on the basis of clock signals which are received from the clock interface 20h (21h) or the synchronize signal received from the clock synchronous interface 20k (21k) to the TDM data-to-IP packet convert block 20b (21b), the IP packet-to-TDM data convert block 20g (21g), and the jitter buffer 20f (21f).

The clock synchronous interface 20k (21k) transmits the synchronize signal received from the clock generate block 20i (21i), to the clock synchronous interface 21k (20k). Furthermore, the clock synchronous interface 20k (21k) transmits a synchronize signal received from the clock synchronous interface 21k (20k) to the clock generate block 20i (21i).

The control interconnect interface 201 (211) transmits a system changeover order received from the control block 20j (21j), to the control interconnect interface 211 (201). The control interconnect interface 201 (211) transmits a system changeover order received from the control interconnect interface 211 (201), to the control block 20j (21j). The control interconnect interface 201 (211) transmits a selector changeover order received from the control block 20j (21j), to the selector 22m.

The TDM data interface 22n includes the selector 22m. In the forward direction, the TDM data interface 22n transmits TDM data received from the convert block 22o, to the TDM data interface 20a and the TDM data interface 21a. In the backward direction, the TDM data interface 22n receives TDM data from the TDM data interface 20a and the TDM data interface 21a. The TDM data interface 22n selects either TDM data received from the TDM data interface 20a or TDM data received from the TDM data interface 21a, and transmits the selected TDM data to the convert block 22o. The TDM data interface 22n receives the selector changeover order from the control interconnect interface 201 (211).

In the backward direction, the selector 22m determines which of the TDM data received from the TDM data interface 20a and the TDM data received from the TDM data interface 21a should be transmitted to the convert block 22o. The determination complies with the selector changeover order received from the control interconnect interface 201 (211).

In the forward direction, the convert block 22o converts a data signal received from the line interface 22p to TDM data, and transmits the data signal to the TOM data interface 22n. In the backward direction, the convert block 22o converts TDM data received from the TOM data interface 22n to a data signal, and transmits the data signal to the line interface 22p.

In the forward direction, the line interface 22p transmits a data signal received from the subscriber terminal 12, to the convert block 22o. In the backward direction, the line interface 22p transmits a data signal received from the convert block 22o, to the subscriber terminal 12.

A flow in the forward direction and a flow in the backward direction will now be described as to the case where the TDM data-IP packet convert module #0 20 (TDM data received from the TDM data-IP packet convert module #1 21) functions as the active system and the TDM data-IP packet convert module #1 21 (TDM data received from the TDM data-IP packet convert module #0 20) functions as the standby system.

It is supposed that the active system IP address is A and the standby system IP address is B. The IP address A is set for the TDM data-IP packet convert module #0 20 (the TOM data-IP packet convert module #1 21) and the IP address B is set for the TDM data-IP packet convert module #1 21 (the TDM data-IP packet convert module #0 20) by immediately preceding system changeover. Both the router A 13 and the router B 14 recognize that the IP address A represents the TDM data-IP packet convert module #0 20 (the TDM data-IP packet convert module #1 21) and the IP address B represents the TDM data-IP packet convert module #1 21 (the TDM data-IP packet convert module #0 20). And the Internet protocol network 15 has already established a route for transmitting packets directed to the IP address A to the router A 13 and a route for transmitting packets directed to the IP address B to the router B 14. The selector 22m selects TDM data transmitted from the TDM data interface 20a (21a). The control block 20j (21j) and the control block 21j (20j) cause communication information to coincide with each other by transmitting and receiving the communication information via the IP packet interconnect interfaces. The clock generate block 20i (21i) uses a synchronize signal generated by itself, and the clock generate block 21i (20i) also uses the synchronize signal received from the clock generate block 20i (21i) via the clock synchronous interface 20k (21k) and the clock synchronous interface 21k (20k). As a result, synchronize signals to be used by the TDM data-to-IP packet convert block 20b, the TDM data-to-IP packet convert block 21b, the IP packet-to-TDM data convert block 20g, the IP packet-to--TDM data convert block 21g, the jitter buffer 20f, and the jitter buffer 21f are made the same.

First, the flow in the forward direction will now be described. The subscriber terminal 12 transmits a data signal to the line interface 22p because of, for example, telephone calling. The line interface 22p transmits the data signal to the convert block 22o. The convert block 22o converts the data signal received from the line interface 22p to TOM data, and transmits the TDM data to the TDM data interface 22n. The TDM data interface 22n transmits the TDM data received from the convert block 22o to the TDM data interface 20a and the TDM data interface 21a. The TDM data interface 20a (21a) transmits the TDM data received from the TDM data interface 22n, to the TDM data-to-IP packet convert block 20b (21b). The TDM data-to-IP packet convert block 20b (21b) converts the TDM data received from the TDM data interface 20a (21a) to IP packets directed to the gateway 11 according to timing of the synchronize signal received from the clock generate block 20i (21i). The TDM data-to-IP packet convert block 20b (21b) transmits the generated IP packets directed to the IP packet forward block 20c (21c). In the same way, the TOM data-to-IP packet convert block 21b (20b) converts the TDM data received from the TOM data interface 21a (20a) to IP packets directed to the gateway 11 according to timing of the synchronize signal received from the clock generate block 21i (20i). IP packets generated by the TDM data-to-IP packet convert block 20b (21b) are made the same as IP packets generated by the TDM data-to-IP packet convert block 21b (20b) by using a method which will be described later. And the TDM data-to-IP packet convert block 21b (20b) transmits IP packets directed to the gateway 11 to the IP packet forward block 21c (20c). The IP packet forward block 20c (21c) transmits the IP packets directed to the gateway 11 and received from the TDM data-to-IP packet convert block 20b (21b), to the IP packet interface 20d (21d). However, the IP packet forward block 21c (20c) discards the generated IP packets directed to the gateway 11. The IP packet interface 20d (21d) transmits the IP packets directed to the gateway 11 and received from the IP packet forward block 20c (21c), to the router A 13 (the router B 14). The router A 13 (the router B 14) transmits the IP packets directed to the gateway 11 and received from the IP packet interface 20d (21d), to the Internet protocol network 15. The Internet protocol network 15 transmits the IP packets directed to the gateway 11 and received from the router A 13 (the router B 14), to the gateway 11. The gateway 11 converts the IP packets received from the Internet protocol network 15 to a data signal, and transmits the data signal to the subscriber terminal 16. The subscriber terminal 16 receives the data signal from the gateway 11.

The flow in the backward direction will now be described. The subscriber terminal 16 transmits a data signal to the gateway 11 because of, for example, telephone calling. The gateway 11 converts the data signal to IP packets directed to the IP address A, and transmits the IP packets to the Internet protocol network 15. The Internet protocol network 15 receives the IP packets directed to the IP address A and received from the gateway 11, and transmits the IP packets to the router A 13 (the router B 14). The router A 13 (the router B 14) transmits the IP packets directed to the IP address A and received from the Internet protocol network 15, to the IP packet interface 20d (21d).

The IP packet interface 20d (21d) transmits the IP packets directed to the IP address A and received from the router A 13 (the router B 14), to the IP packet forward block 20c (21c). The IP packet forward block 20c (21c) transmits the IP packets directed to the IP address A and received from the IP packet interface 20d (21d), to the jitter buffer 20f (21f). The jitter buffer 20f (21f) ascertains that the IP packets received from the IP packet forward block 20c (21c) are directed to itself, and stores the IP packets in the buffer. If a determinate number of IP packets are stored in the buffer, then the jitter buffer 20f (21f) transmits the stored IP packets to the IP packet-to-TDM data convert block 20g (21g) in the order of the sequence number according to the synchronize signal supplied from the clock generate block 20i (21i). The IP packet-to-TDM data convert block 20g (21g) converts the IP packets received from the jitter buffer 20f (21f) to TDM data in accordance with the synchronize signal supplied from the clock generate block 20i (21i), and transmits the TOM data to the TDM data interface 20a (21a). The TDM data interface 20a (21a) transmits the TDM data received from the IP packet-to-TDM data convert block 20g (21g), to the TDM data interface 22n. The TDM data interface 22n transmits the TDM data received from the TDM data interface 20a (21a) which is selected by the selector 22m, to the convert block 22o. The convert block 22o converts the TDM data received from the TDM data interface 22n to a data signal, and transmits the data signal to the line interface 22p. The line interface 22p transmits the received data signal to the subscriber terminal 12. The subscriber terminal 12 receives the data signal from the line interface 22p.

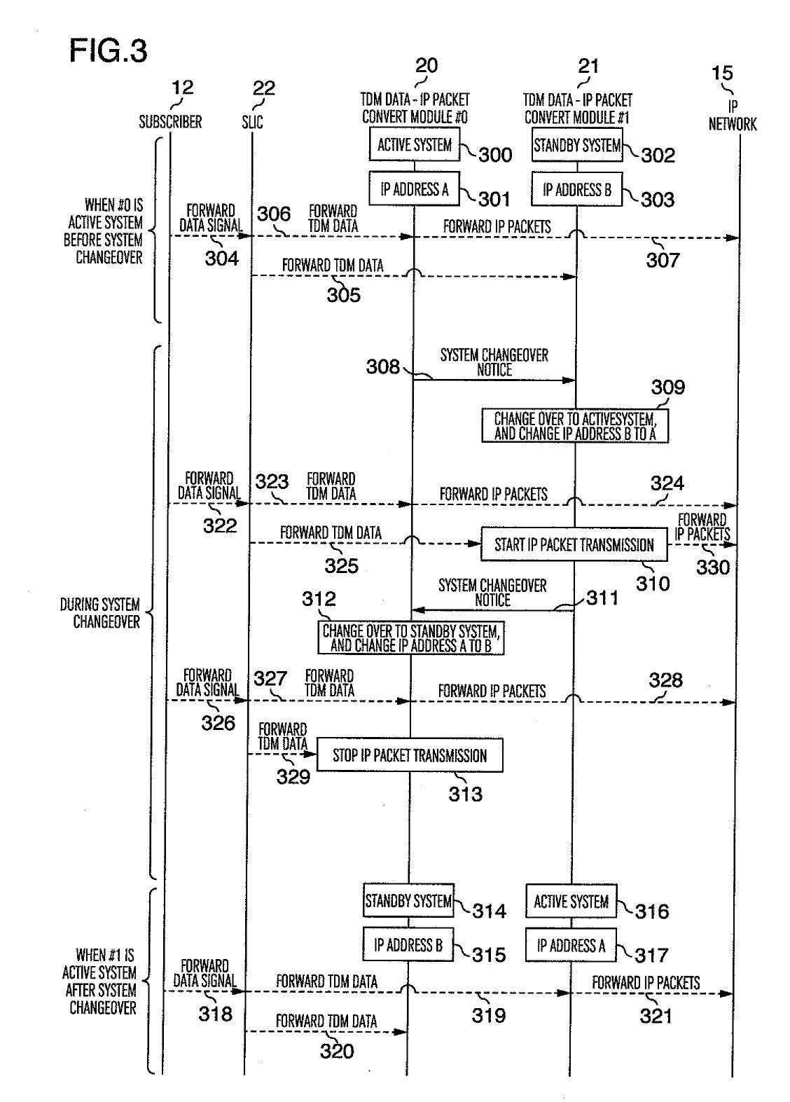

FIG. 3 is a diagram for explaining, as to a flow in the forward direction, an operation sequence in the case where a state in which the TDM data-IP packet convert module #0 (the TDM data-IP packet convert module #1) functions as the active system and the TDM data-IP packet convert module #1 (the TDM data-IP packet convert module #0) functions as the standby system is changed over to a state in which the TOM data-IP packet convert module #1 (TDM data-IP packet convert module #0) functions as the active system and the TDM data-IP packet convert module #0 (TOM data-IP packet convert module #1) functions as the standby system.

First, the TDM data-IP packet convert module #0 20 (the TDM data-IP packet convert module #1 21) functions as the active system, and it uses the IP address A (steps 300 and 301). The TDM data-IP packet convert module #1 21 (the TDM data-IP packet convert module #0 20) functions as the standby system, and it uses the IP address B (steps 302 and 303). The subscriber terminal 12 transmits a data signal to the subscriber loop interface circuit 22 because of, for example, telephone calling (step 304). The subscriber loop interface circuit 22 converts the data signal received from the subscriber terminal 12 to TDM data, and transmits the TDM data to the TDM data-IP packet convert module #0 20 and the TDM data-IP packet convert module #1 21 (steps 305 and 306). The TDM data-IP packet convert module #0 20 (the TDM data-IP packet convert module #1 21) converts the TDM data to IP packets directed to the gateway 11, and transmits the IP packets to the Internet protocol network 15 via the router A 13 (the router B 14) (step 307). The TDM data-IP packet convert module #1 21 (the TDM data-IP packet convert module #0 20) does not transmit IP packets directed to the Internet protocol network 15 because the IP packet forward block 21c (20c) stops transmission of IP packets obtained by conversion.

A flow in the forward direction during system changeover will now be described. The control block 20j (21j) generates a system changeover order (for causing the TDM data-IP packet convert module #1 21 (the TDM data-IP packet convert module #0 20) to function as the active system) in accordance with a maintenance command or a predetermined schedule, and transmits the generated system changeover order to the control interconnect interface 201 (211). The control interconnect interface 201 (211) transmits the system changeover order (for causing the TDM data-IP packet convert module #1 21 (the TDM data-IP packet convert module #0 20) to function as the active system) received from The control block 20j (211), to the control interconnect interface 211 (201) (step 308). The control interconnect interface 211 (201) transmits the received system changeover order (for causing the TDM data-IP packet convert module #1 21 (the TDM data-IP packet convert module #0 20) to function as the active system) to the control block 211 (20j). The control block 211 (20j) receives the system changeover order (for causing the TDM data-IP packet convert module #1 21 (the TDM data-IP packet convert module #0 20) to function as the active system) from the control interconnect interface 211 (201), conducts the changeover from the standby system to the active system, and makes a change from the IP address B to the IP address A (step 309).

Because of changeover to the active system, the IP packet forward block 21c (20c) starts transmission of IP packets directed to the gateway 11 and received from the TDM data-to-IP packet convert block 21b (20b), to the IP packet interface 21d (20d). The IP packet interface 21d transmits IP packets directed to the gateway 11 to the Internet protocol network 15 via the router B 14 (step 310). At this time point, the data signal from the subscriber terminal 12 is converted to TDM data by the subscriber loop interface circuit 22, and the TDM data is transmitted to both the TDM data-IP packet convert module #1 21 and the TDM data-IP packet convert module #0 20 (steps 322, 323 and 325). The TDM data-IP packet convert module #0 20 converts the received TDM data to IP packets directed to the gateway 11, and transmits the IP packets to the Internet protocol network 15 (step 324). In the same way, the TDM data-IP packet convert module #1 21 converts the received TDM data to IP packets directed to the gateway 11, and transmits the IP packets to the Internet protocol network 15 (step 330). The 12 packets directed to the gateway 11 and generated by the TDM data-to-IP packet convert block 20b and the IP packets directed to the gateway 11 and generated by the TDM data-to-IP packet convert block 21b are made the same by using a method which will be described later. As a result, the IP packets directed to the gateway 11 and transmitted to the Internet protocol network 15 by the TDM data-IP packet convert module #0 20 become the same as the IP packets transmitted to the Internet protocol network 15 by the TDM data-IP packet convert module #1 21.

Upon starting transmission of IP packets to the Internet protocol network 15, the control block 21j (20j) generates a system changeover order (for causing the TDM data-IP packet convert module #0 20 (the TDM data-IP packet convert module #1 21) to function as the standby system) and transmits the system changeover order to the control interconnect interface 211 (201). The control interconnect interface 211 (201) transmits the system changeover order (for causing the TDM data-IP packet convert module #0 20 (the TDM data-IP packet convert module #1 21) to function as the standby system) received from the control block 21j (20j), to the control interconnect interface 201 (211) (step 311).

The control block 20j (21j) receives the system changeover order (for causing the TDM data-IP packet convert module #0 20 (the TDM data-IP packet convert module #1 21) to function as the standby system) from the control interconnect interface 201 (211), conducts the changeover from the active system to the standby system, and makes a change from the IP address A to the IP address B (step 312).

The IP packet forward block 20c (21c) stops transmission of the IP packets directed to the gateway 11 and received from the TDM data-to-IP packet convert block 20b (21b), to the IP packet interface 20d (21d) because of becoming the standby system. As a result, the TDM data-IP packet convert module #0 20 (the TOM data-IP packet convert module #1 21) stops transmission of IP packets directed to the gateway 11, to the Internet protocol network 15 (step 313).

At this time point, the data signal from the subscriber terminal 12 is converted to the TDM data by the subscriber loop interface circuit 22, and the TDM data is transmitted to both the TOM data-IP packet convert module #1 21 and the TDM data-IP packet convert module #0 20 (steps 326, 327 and 329). The TDM data-IP packet convert module #1 21 and the TDM data-IF packet convert module #0 20 conduct processing of conversion to IP packets. However, only the TDM data-IP packet convert module #1 21 (the TDM data-IP packet convert module #0 20) transmits IP packets directed to the gateway 11, to the Internet protocol network 15 (step 328). As heretofore described, the system changeover is completed.

After the system changeover, the TOM data-IP packet convert module #1 21 (the TDM data-IP packet convert module #0 20) functions as the active system, and it uses the IP address A (steps 316 and 317). The TDM data-IP packet convert module #0 20 (the TDM data-IP packet convert module #1 21) functions as the standby system, and it uses the IP address B (steps 314 and 315). The subscriber terminal 12 transmits a data signal to the subscriber loop interface circuit 22 (step 318). The subscriber loop interface circuit 22 converts the data signal received from the subscriber terminal 12 to TDM data, and transmits the TDM data to the TDM data-IP packet convert module #0 20 and the TOM data-IP packet convert module #1 21 (steps 319 and 320). The TDM data-IP packet convert module #1 21 (the

TOM data-IP packet convert module #0 20) converts the received TDM data to IP packets directed to the gateway 11, and transmits the IP packets to the Internet protocol network 15 via the router B 14 (the router A 13) (step 321).

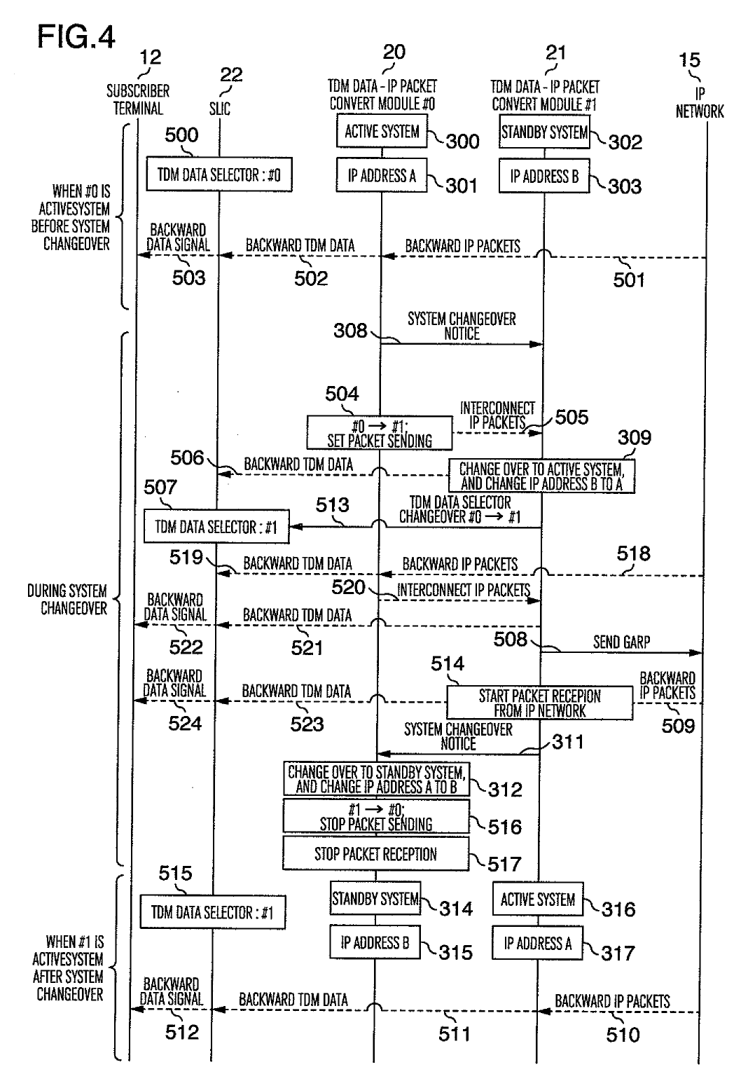

FIG. 4 is a diagram for explaining, as to a flow in the backward direction, an operation sequence in the case where a state in which the TDM data-IP packet convert module #0 (TDM data-IP packet convert module #1) functions as the active system, and the TDM data-IP packet convert module #1 (TDM data-IP packet convert module #0) functions as the standby system is changed over to a state in which the TDM data-IP packet convert module #1 (TDM data-IP packet convert module #0) functions as the active system and the TOM data-IP packet convert module #0 (TDM data-IP packet convert module #1) functions as the standby system.

First, the TDM data-IP packet convert module #0 20 (the TDM data-IP packet convert module #1 21) functions as the active system, and it uses the IP address A (steps 300 and 301). The TOM data-IP packet convert module #1 21 (the TDM data-IP packet convert module #0 20) functions as the standby system, and it uses the IP address B (steps 302 and 303). The selector 22m selects TDM data transmitted from the TDM data-IP packet convert module #0 20 (the TDM data-IP packet convert module #1 21) (step 500). The Internet protocol network 15 transmits IP packets directed to the IP address A to the TDM data-IP packet convert module #0 20 (the TDM data-IP packet convert module #1 21) via the router A 13 (the router B 14) (step 501). The TDM data-IP packet convert module #0 20 (the TDM data-IP packet convert module #1 21) converts the IP packets received from the Internet protocol network 15 to TDM data, and transmits the TDM data to the subscriber loop interface circuit 22 (step 502). The subscriber loop interface circuit 22 converts the TDM data received from the TDM data-IP packet convert module #0 20 (the TDM data-IP packet convert module #1 21) to a data signal, and transmits the data signal to the subscriber terminal 12 (step 503).

A flow in the backward direction during system changeover will now be described. The control block 20j (21j) generates a system changeover order (for causing the TDM data-IP packet convert module #1 21 (the TDM data-IP packet convert module #0 20) to function as the active system) in accordance with a maintenance command or a predetermined schedule, and transmits the generated system changeover order to the control interconnect interface 201 (211). The control interconnect interface 201 (211) transmits the system changeover order (for causing the TDM data-IP packet convert module #1 21 (the TDM data-IP packet convert module #0 20) to function as the active system) received from the control block 20j (21j), to the control interconnect interface 211 (201) (step 308).

Upon transmitting the system changeover order (for causing the TDM data-IP packet convert module #1 21 (the TDM data-IP packet convert module #0 20) to function as the active system), the IP packet forward block 20c (21c) conducts mirroring on each of IP packets directed to the IP address A and received from the IP packet interface 20d (21d), and transmits one IP packet to the jitter buffer 20f (21f) and transmits the other IP packet to the IP packet interconnect interface 20e (21e) (step 504). The IP packet interconnect interface 20e (21e) transmits IP packets directed to the IP address A and received from the IP packet forward block 20c (21c) to the IP packet interconnect interface 21e (20e) (step 505). The IP packet interconnect interface 21e (20e) transmits the IP packets directed to the IP address A and received from the IP packet interconnect interface 21e (20e) to the jitter buffer 21f (20f). At this time point, the IP address of the TDM data-IP packet convert module #1 21 (the TDM data-IP packet convert module #0 20) is B. Therefore, the jitter buffer 21f (20f) discards the IP packets directed to the IP address A and received from the IP packet interconnect interface 21e (20e).

Upon receiving the changeover order (for causing the TDM data-IP packet convert module #1 21 (the TDM data-IP packet convert module #0 20) to function as the active system) from the control interconnect interface 201 (211), the control interconnect interface 211 (201) transmits the system changeover order to the control block 21j (20j). The control block 21j (20j) receives the changeover order (for causing the TDM data-IP packet convert module #1 21 (the TDM data-IP packet convert module #0 20) to function as the active system) from the control interconnect interface 211 (201), conducts the changeover from the standby system to the active system, and makes a change from the IP address B to the IP address A (step 309). Since the own IP address becomes A, the jitter buffer 21f (20f) does not discard the IP packets directed to the IP address A and received from the IP packet interconnect interface 21e (20e). If a sequence number is repeated, storage into the buffer is conducted by discarding IP packets received later. If a determinate number of IP packets are stored in the buffer, then the jitter buffer 21f (20f) transmits the stored IP packets to the IP packet-to-TDM data convert block 21g (20g) in the order of the sequence number according to timing of the synchronize signal supplied from the clock generate block 21i (20i). The IP packet-to-TDM data convert block 21g (20g) converts the IP packets received from the jitter buffer 21f (20f) to TDM data according to timing of the synchronize signal supplied from the clock generate block 21i (20i). The IP packet-to-TDM data convert block 21g (20g) transmits the generated TDM data to the TDM data interface 21a (20a). The TDM data interface 21a (20a) transmits the TDM data received from the IP packet-to-TDM data convert block 21g (20g), to the TOM data interface 22n (step 506). The IP packets generated by the TDM data-to-IP packet convert block 21b and the IP packets generated by the TDM data-to-IP packet convert block 20b are made the same by using a method which will be described later. As a result, the IP packets transmitted by the TDM data-IP packet convert module #1 21 become the same as the IP packets transmitted by the TDM data-IP packet convert module #1 21.

After becoming the active system, the control block 211 (201) transmits a selector changeover order to the control interconnect interface 211 (201). The control interconnect interface 211 (201) transmits the selector changeover order received from the control block 21j (20j), to the selector 22m (step 513). According to the changeover order received from the control block 211 (20j), the selector 22m changes TDM data to be transmitted to the convert block 22o from

TDM data received from the TOM data interface 20a to TOM data received from the TOM data interface 21a (step 507).

At this time point, IP packets directed to the IP address A and transmitted from the Internet protocol network 15 arrive at the TDM data-IP packet convert module #0 20 (the TDM data-IP packet convert module #1 21) (step 518). The TDM data-IP packet convert module #0 20 (the TDM data-IP packet convert module #1 21) converts the IP packets to TDM data, and transmits the TDM data to the subscriber loop interface circuit 22. Since the selector 22m selects the TDM data-IP packet convert module #1 21 (the TDM data-IP packet convert module #0 20), however, the TDM data transmitted by the TDM data-IP packet convert module #0 20 (the TDM data-IP packet convert module #1 21) is not converted (step 519). The TDM data-IP packet convert module #0 20 (the TDM data-IP packet convert module #1 21) transmits the received IP packets directed to the IP address A to the TDM data-IP packet convert module #1 21 (the TDM data-IP packet convert module #0 20) (step 520). The TDM data-IP packet convert module #1 21 (the TDM data-IP packet convert module #0 20) converts the IP packets directed to the IP address A and received from the TDM data-IP packet convert module #0 20 (the TDM data-IP packet convert module #1 21) to TDM data, and transmits the TDM data to the subscriber loop interface circuit 22 (step 521). Since the selector 22m has selected the TDM data-IP packet convert module #1 21 (the TDM data-IP packet convert module #0 20), the subscriber loop interface circuit 22 converts the TDM data received from the TDM data-IP packet convert module #1 21 (the TDM data-IP packet convert module #0 20) to a data signal, and transmits the data signal to the subscriber terminal 12 (step 522). Then, the control block 21j (20j) transmits a

GARP to the IP packet interface 21d (20d). The IP packet interface 21d (20d) transmits the GARP received from the control block 21j (20j), to the router A 13, the router B 14, the Internet protocol network 15, and the gateway 11.

Routing information for the IP address A and the IP address B in the Internet protocol network 15, the router A 13, the router B 14 is changed according to the GARP. The Internet protocol network 15 transmits the IP packets directed to the IP address A, to the IP packet interface 21d (20d) via the router B 14 (the router A 13) (steps 509 and 514).

The IP packet interface 21d (20d) transmits the IP packets received from the Internet protocol network 15, to the IP packet forward block 21c (20c).

Immediately after the GARP issue, there is a possibility that the IP packet interface 20d (21d) will also receive the IP packets directed to the IP address A. Therefore, there is a possibility that the IP packet forward block 21c (20c) will receive IP packets directed to the IP address A from two directions, i.e., the IP packet interconnect interface 21e (20e) and the IP packet interface 21d (20d). The IP packet forward block 21c (20c) transmits IP packets received from the two directions to the jitter buffer 21f (20f). As for IP packets having a repeated sequence number, the jitter buffer 21f (20f) conducts storage into the buffer by discarding IP packets received later, and aligns IP packets by transmitting the IP packets to the IP packet to the TDM data convert block 21g (20g) in the order of the sequence number. The IP packet-to-TDM data convert block 21g (20g) converts the IP packets to TDM data, and transmits the TDM data to the TDM data interface 21a (20a). The TDM data interface 21a (20a) transmits the received TDM data to the TDM data interface 22n (step 523). The subscriber loop interface circuit 22 converts the TDM data received from the TDM data-IP packet convert module #1 21 (the TDM data-IP packet convert module #0 20) to a data signal, and transmits the data signal to the subscriber terminal 12 (step 524).

If the IP packet interface 21d (20d) has been able to receive IP packets directed to the IP address A, then the control block 21j (20j) generates a system changeover order (for causing the TDM data-IP packet convert module #0 20 (the TDM data-IP packet convert module #1 21) to function as the standby system), and transmits the system changeover order to the control interconnect interface 211 (201). The control interconnect interface 211 (201) transmits the system changeover order (for causing the TDM data-IP packet convert module #0 20 (the TOM data-IP packet convert module #1 21) to function as the standby system) received from the control block 21j (20j), to the control interconnect interface 201 (211) (step 311). The control interconnect interface 201 (211) transmits the system changeover order (for causing the TDM data-IP packet convert module #0 20 (the TDM data-IP packet convert module #1 21) to function as the standby system) received from the control interconnect interface 211 (201), to the control block 20j (21j).

The control block 20j (21j) receives the system changeover order from the control interconnect interface 201 (211), conducts the changeover from the active system to the standby system, and makes a change from the IP address A to the IP address B (step 312).

The IP packet forward block 21c (20c) terminates the mirroring in the IP packet forward block 20c (21c) in response to the changeover from the active system to the standby system (step 516). Since the own IP address becomes B, the jitter buffer 20f (21f) discards IP packets directed to the IP address A. As a result, the TDM data-IP packet convert module #0 20 (the TDM data-IP packet convert module #1 21) stops transmission of TDM data to the subscriber loop interface circuit 22 (step 517). As heretofore described, the system changeover is completed.

After the system changeover, the TDM data-IP packet convert module #1 21 (the TDM data-IP packet convert module #0 20) functions as the active system, and it uses the IP address A (steps 316 and 317). The TDM data-IP packet convert module #0 20 (the TDM data-IP packet convert module #1 21) functions as the standby system, and it uses the IP address B (steps 314 and 315). The selector 22m selects TDM data transmitted from the TDM data-IP packet convert module #1 21 (the TDM data-IP packet convert module #0 20). The Internet protocol network 15 transmits IP packets directed to the IP address A to the TDM data-IP packet convert module #1 21 (the TDM data-IP packet convert module #0 20) via the router B 14 (the router A 13) (step 510). The TDM data-IP packet convert module #1 21 (the TDM data-IP packet convert module #0 20) converts IP packets received from the Internet protocol network 15, to TDM data, and transmits the TDM data to the subscriber loop interface circuit 22 (step 511). The subscriber loop interface circuit 22 converts the TDM data received from the TDM data-IP packet convert module #1 21 (the TDM data-IP packet convert module #0 20), to a data signal, and transmits the data signal to the subscriber terminal 12 (step 512).

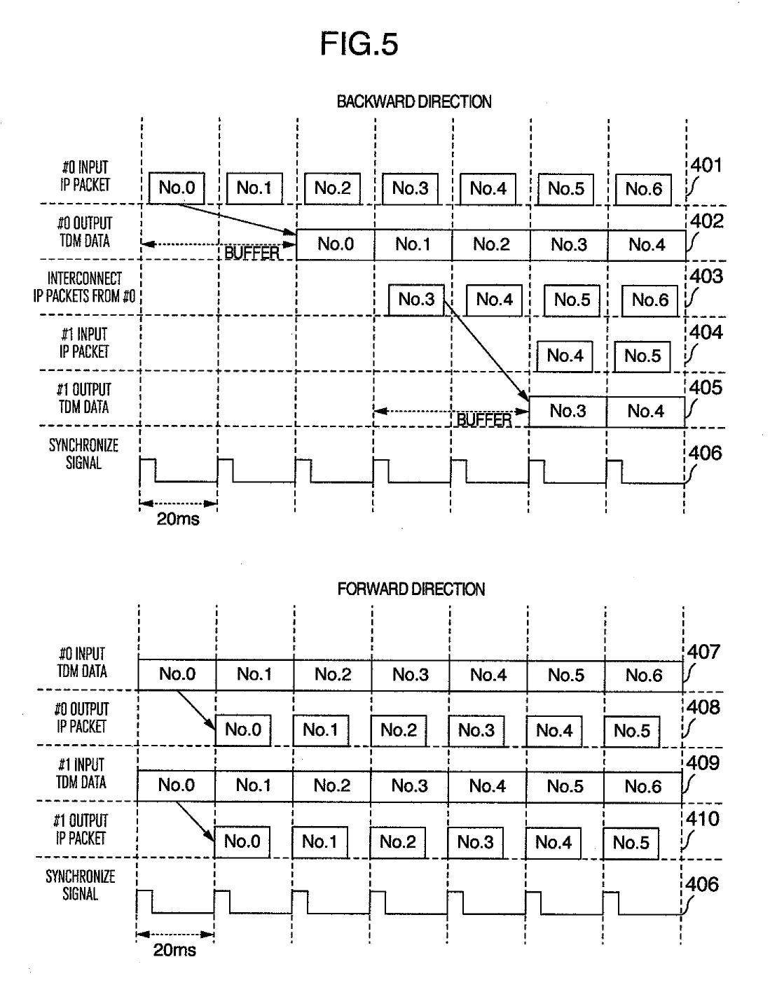

FIG. 5 is a diagram showing a method by which the TDM data-IP packet convert module #1 (the TDM data-IP packet convert module #0) generates the same TDM data and the same IP packets as those in the TDM data-IP packet convert module #0 (the TDM data-IP packet convert module #1).

The synchronize signals are matched to each other via the clock synchronous interface 20k (21k) as described earlier. As a result, synchronize signals used by the TDM data-to-IP packet convert block 20b, the TDM data-to-IP packet convert block 21b, the IP packet-to-TDM data convert block 20g, the IP packet-to-TDM data convert block 21g, the jitter buffer 20f, and the jitter buffer 21f are made the same (406). Furthermore, since the clock source is the same, the clock in use also becomes the same.

As an example, the case where the repetition period of the synchronize signal is set equal to 20 ms and the jitter buffer length on the backward side is set equal to two IP packets will now be described. No. in FIG. 5 indicates a sequence number. In the backward direction, the IP packet-to-TDM data convert block 20g (21g) converts IP packets to TDM data with a repetition period of 20 ms. It is supposed that the jitter buffer 20f (21f) receives IP packets from the Internet protocol network 15 regularly (401). After storing two IP packets, the jitter buffer 20f (21f) transmits them to the IP packet-to-TDM data convert block 20g (21g). As a result, timing of transmission of TDM data obtained by converting the IP packets in the IP packet-to-TDM data convert block 20g (21g) is delayed by 40 ms from the original timing (402). As a result of system changeover, the jitter buffer 21f (20f) starts reception of IP packets from the TDM data-IP packet convert module #0 20 (the TDM data-IP packet convert module #1 21) and IP packets from the Internet protocol network 15 (403, 404). If the jitter buffer 21f (20f) has received IP packets having the same sequence number doubly, the jitter buffer 21f (20f) discards an IP packet received later. After storing two IP packets, the jitter buffer 21f (20f) transmits them to the IP packet-to-TDM data convert block 21g (20g) in the same way as the jitter buffer 20f (21f). As a result, timing of transmission of TDM data obtained by converting the IP packets in the IP packet-to-TDM data convert block 21g (20g) is delayed by 40 ms from the original timing (405). Even if the delay dispersion of IP packets received by the jitter buffer 21f (20f) is large, it is possible to cause timing of transmission of TDM data obtained by converting IP packets in the IP packet-to-TDM data convert block 21g to becomes the same as timing of transmission of TDM data obtained by converting IP packets in the IP packet-to-TDM data convert block 20g by prolonging the jitter buffer length.

Owing to operations heretofore described, the TDM data-IP packet convert module #1 21 (the TDM data-IP packet convert module #0 20) generates the same TDM data as the TDM data-IP packet convert module #0 20 (the TDM data-IP packet convert module #1 21) does.

In the forward direction, the TDM data-to-IP packet convert block 20b (21b) converts TDM data to IP packets with a repetition period of 20 ms (407, 408). Since the TDM data-to-IP packet convert block 21b (the TDM data-to-IP packet convert block 20b) receives the same TDM data as the TDM data-to-IP packet convert block 20b (the TDM data-to-IP packet convert block 21b) does, the same IP packets are generated by conducting the conversion with the repetition period of 20 ms (409, 410). Owing to operations heretofore described, the TDM data-IP packet convert module #1 21 (the TDM data-IP packet convert module #0 20) generates the same TDM data as the TDM data-IP packet convert module #0 20 (the TDM data-IP packet convert module #1 21) does.

The present invention can be used in media conversion between a telephone system and an IP-based voice network system.

It should be further understood by those skilled in the art that although the foregoing description has been made on embodiments of the invention, the invention is not limited thereto and various changes and modifications may be made without departing from the spirit of the invention and the scope of the appended claims.

1. A communication system comprising a first terminal, a second terminal, a first manage module connected to the first terminal, a second manage module connected to the second terminal and connected to the first manage module via an Internet protocol (IP) network, and a clock supply module connected to the first manage module and the second manage module,
wherein
the clock supply module transmits a synchronize signal to the first manage module and the second manage module,
the first manage module comprises:
a first circuit for converting a signal to be transmitted to the first terminal and a signal received from the first terminal;
a first convert module for receiving a signal transmitted from the first circuit, and converting time division multiplexed (TDM) data to IP packets and vice versa; and
a second convert module for receiving a signal transmitted from the first circuit, and converting TDM data to IP packets and vice versa, and
the first convert module and the second convert module synchronize IP packet processing by using the synchronize signal supplied from the clock supply module.

2. The communication system according to claim 1, wherein the first convert module and the second convert module are changed over between an active system and a standby system and vice versa.

3. The communication system according to claim 1, wherein the first convert module and the second convert module transmit and receive information mutually.

4. The communication system according to claim 2, wherein each of the first convert module and the second convert module is assigned an active system IP address when it functions as the active system, and assigned a standby system IP address when it functions as the standby system.

5. The communication system according to claim 4, wherein active system IP address and the standby system IP address are common to the first convert module and the second convert module.

6. The communication system according to claim 4, wherein at time of changeover between the active system and the standby system and vice versa, the first convert module and the second convert module transmit routing change information to the Internet protocol network and the second manage module.

7. The communication system according to claim 1, wherein when transmitting information which originates in the first terminal from the first manage module to the second manage module, the first convert module receives TDM data from the first circuit, and converts the TDM data to IP data in accordance with the synchronize signal.

8. The communication system according to claim 1, wherein
the first convert module comprises a buffer, and
when transmitting information which originates in the second terminal from the second manage module to the first manage module, the first convert module transmits IP packets received from the Internet protocol network, to the buffer and the second convert module.

9. The communication system according to claim 8, wherein when a predetermined number of the IP packets have been stored in the buffer, the first convert module converts the IP packets to TDM data in accordance with the synchronize signal.

10. The communication system according to claim 1, wherein when transmitting information which originates in the first terminal from the first manage module to the second manage module, the first convert module and the second convert module receive TDM data from the first circuit, and converts the TDM data to same IP data in accordance with the synchronize signal.

11. The communication system according to claim 1, wherein
the first convert module comprises a buffer,
when transmitting information which originates in the second terminal from the second manage module to the first manage module, the first convert module transmits IP packets received from the Internet protocol network, to the buffer and the second convert module, and the first convert module and the second convert module convert the IP packets to same TDM data.

12. The communication system according to claim 8, wherein the buffer judges coincidence of destination IP address of the transmitted IP packets.

13. The communication system according to claim 8, wherein when a sequence number is repeated in the transmitted IP packets, the buffer discards IP packets received later.
